(19) United States
(12) Patent Application Publication
(10) Pub. No.: US 2011/0297101 A1
(43) Pub. Date: Dec. 8, 2011

(54) Massaging Pet Brush With Interchangeable Heads

(75) Inventor: JUAN FERNANDEZ, TOWACO, NJ (US)

(73) Assignee: PRODUCTS OF TOMORROW, INC., Towaco, NJ (US)

(21) Appl. No.: 13/153,830

(22) Filed: Jun. 6, 2011

Related U.S. Application Data
(60) Provisional application No. 61/352,436, filed on Jun. 8, 2010.

(51) Int. Cl. A01K 13/00

(52) U.S. Cl. 119/603; 119/612; 119/600

(57) ABSTRACT

The present invention is a pet grooming device. It contains a head with bristles; the head can be interchanged with other heads for versatility. It contains a vibration device for messaging pets that vibrates the head and bristles, as well as a push plate to remove hair or fur from the bristles. The present invention is self-contained and battery operated, so it is easy to use and can be used anywhere.

### CLAIM OF PRIORITY

This application claims priority to U.S. Ser. No. 61/352,436 filed Jun. 8, 2010, the contents of which are fully incorporated herein by reference.

### FIELD OF THE INVENTION

The invention relates to pet products, in particular to devices for grooming pets.

### BACKGROUND OF THE INVENTION

Many people keep pets and enjoy grooming them, especially dogs and cats. While in the past it has been customary to groom pets with combs and brushes, some pet owners like to pamper their pets further.

The present invention is a massaging pet brush with interchangeable heads that can vibrate. The vibration motion gives the pet a soothing massage, and is especially helpful for older pets that may have health problems such as arthritis. The vibration of the brush bristles is also useful in removal of tangles from a pet's fur or hair, by using the vibration motion to gently coax a tangle out instead of pulling as one does with a comb or brush.

### SUMMARY OF THE INVENTION

The present invention is a pet grooming tool that is a pet brush with a massage function.

In a preferred embodiment, a battery is disposed in the handle of the brush, and may be connected to a motor in the body of the brush near the head of the brush. This may cause bristles disposed on the head of the brush to vibrate when the motor is engaged. The level of vibration may, for instance, be adjustable. The head may also interchangeable with other heads. In addition, a preferred embodiment of the invention may contain a push plate on the head that allows easy removal of hair or fur from the brush bristles.

The present invention has the advantages of being one compact unit, battery operated, and therefore easy to use. In addition, the heads may be interchangeable but may still retain the ability to be vibrated, which is perceived as an advantage over brushes in the prior art. Interchangeable heads give the user flexibility in that the brush can be used on various types of animals, and different types of heads can be used for different types of applications.

It is an object of the invention to provide a device for massaging pets.

It is an object of the invention to provide a device for brushing a pet's fur or hair.

It is an object of the invention to provide a device with interchangeable brush heads.

It is an object of the invention to provide a device with a push plate to remove hair from the brush head.

It is an object of the invention to provide a compact device that is easy to use and transport.

It is an object of the invention to provide a device that can be used in any place or setting.

### BRIEF DESCRIPTION OF THE DRAWINGS

FIG. 1 is a side view of a preferred embodiment of the invention.

FIG. 2 is a cross sectional view of a preferred embodiment of the invention.

FIG. 3 is a side view of a preferred embodiment of the invention during use.

### DESCRIPTION OF THE PREFERRED EMBODIMENTS

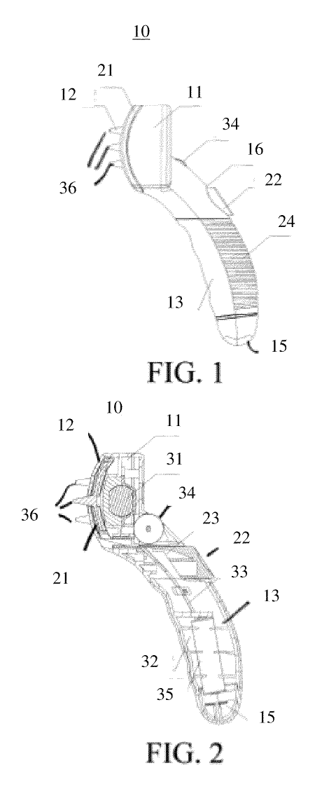

FIG. 1 shows a pet grooming tool 10 with body 11, head 12, handle 13, handle covering 14, rear cover 15, opening 16, push plate 21, button 22, vibration level control knob 34, and bristles 36.

FIG. 2 shows a pet grooming tool 10 with body 11, head 12, handle 13, rear cover 15, push plate 21, button 22, reset device 23, electrical vibration device 31, battery compartment 32, electrical connection 33, vibration level control knob 34, battery 35, and bristles 36.

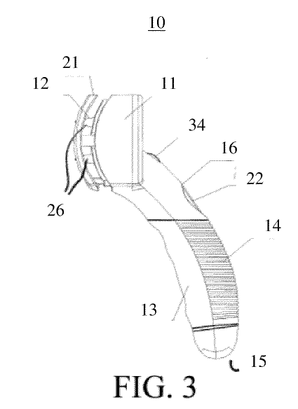

FIG. 3 shows a pet grooming tool 10 with body 11, head 12, handle 13, handle covering 14, rear cover 15, opening 16, push plate 21, button 22, vibration level control knob 34, and bristles 36.

FIGS. 1 and 3 illustrate the invention as seen by a user.

In a preferred embodiment, the handle 12 may be sized and shaped to fit a grasping adult human hand. The handle 12 may also be designed to house a standard battery such as, but not limited to, a battery designed for a portable flashlight, a remote control or some other portable electronic device.

The body 11 may be rigidly connected to the handle. The body 11 may contain a battery powered DC motor that may be functionally connected to the standard battery via a voltage or current controlling device such as, but not limited to, a variable potentiometer.

The body 11 may also contain a vibration causing, rotatable element 31 that may have an eccentric weight distribution. The vibration causing element 31 may be connected to the DC motor such that rotation of the motor causes the rotatable element to rotate and, because of its eccentric weight distribution, vibrate.

In a preferred embodiment, there may be a vibration level control knob that may be mechanically connected to the variable potentiometer in such a way that movement of the control knob alters an amount of current flowing through it. In this way, a user may vary the speed of rotation of the motor and hence the speed of rotation of the rotatable element. This change of speed of rotation may alter the magnitude or degree of vibration caused by the eccentrically weighted, rotatable element.

The head 12 is preferably removably attached to the body. The head 12 may have one or more bristles attached to the bristle face of the head.

In a preferred embodiment, there may be a push plate that is removably attached to the head. The push plate may be shaped to conform to the bristle face of the head, and may have one or more holes through it that are shaped to be a close fit to the one or more bristles on the head.

When the user is ready to groom his pet, they may use the pet grooming tool 10 as shown in FIG. 1. The user may grasp the handle 13 and contacts the pet's body with the bristles 36 on the head 12. The user may then brush the pet's fur or hair with the invention, and may activate the massaging vibration by rotating the vibration level control knob 34, which may also allow them to adjust the vibration level. The pet may then enjoy a soothing massage while being brushed and groomed.

FIG. 3 shows how the pet grooming tool 10 may be cleaned. Often when grooming an animal the bristles of the grooming tool become clogged with fur or hair, and the groomer must pause to remove it. This process typically takes both hands, and an uncooperative animal may escape while the groomer is cleaning the brush. With the present invention, if the bristles 36 of the head 12 become clogged with hair or fur, the user may quickly and easily clean them by depressing the button 22. The button recedes into the opening 16. This may cause the push plate 21 to move to the position seen in FIG. 3. The push plate has holes that are forced across the bristles and remove fur and hair as they make contact. The user may easily pull or wipe the hair from the push plate and the ends of the bristles, then release the button. When the button 22 is released, the push plate may return to its original position as seen in FIG. 1. The user may choose to keep the massaging vibration on during this process or may turn it off; keeping it on may help with the fur removal by adding kinetic energy to the process. The push plate may be optional and the brush may be sold with or without the push plate.

Using the push plate to remove fur or hair may be much easier and faster than trying to remove the fur or hair by hand, and thus speeds the grooming process. This may be important in pet salons where a groomer is typically paid by the job, as it may speed the process and allows the groomer to complete jobs faster. Additionally, the push plate may be employed using the same hand that is holding the invention, leaving one hand free to control the animal. The fur or hair may be easily pulled off the push plate with the hand holding the animal, or the hair or fur can be wiped off, for instance onto an apron. These advantages may be especially helpful with a finicky animal; the animal is not released and thus may not escape, and the delay time for cleaning the bristles may be lessened so the animal doesn't have as much time or opportunity to act in an unruly manner.

FIG. 2 is a cross sectional view of a preferred embodiment of the invention. The battery 35 is shown as residing in a battery compartment 32 in the handle 13. The rear cover 15 may open to allow the battery 35 to be easily changed by the user. An electrical connection 33, preferably a wire or series of wires, may connect the battery 35 to the electrical vibration device 31, which is preferably a direct current motor. This motor causes a vibration of the head 12, which in turn vibrates the bristles 36. The electrical vibration device 31 is preferably powered by the battery 35, but may use electrical power from an outlet as well. The battery 35 may be rechargeable and there may be a connection in the rear cover 15 that allows the battery to be recharged in a charger or directly in a wall socket.

FIG. 2 also shows the button 22 and the reset device 23 which may operate the push plate 21. The button 22 may, for instance, be depressed to force the push plate 21 away from the head 11 and thus to clean hair or fur from the bristles 36. When the button 22 is released, the reset device 23 may engage and cause the push plate 21 to return to its original position. The push plate may have a stop position in between the fully extended and original positions; this stop position may be achieved with a catch on the reset device.

The vibration level control knob 34 is shown as an adjustable device that is rotated to increase or decrease the vibration frequency. It may be connected to the electrical vibration device 31 through the electrical connection 33. The batteries may be connected to the rotary switch, which is a potentiometer/rheostat) which controls the current feeding the motor and therefore the degree of vibration.

The head 12 may be fixed or may be interchangeable. Different heads may have different numbers of bristles or bristles of differing sizes or compositions, or may have bristles arranged in different patterns. For instance, one may use one head for grooming a dog, a different head for grooming a cat, and another type of head altogether for grooming a horse. The head may be any shape and may have any number of bristles or groupings of bristles. The bristles may, for instance, be made cone-shaped and made of a flexible or a hard rubber, or they may be thin and cylindrical and made of horse hair. Any combination of shapes and materials may be used for the bristles, and one head may have one type or a variety of types of bristles on it. The bristles may be differing lengths.

The head may be any shape. A round shape is preferred, but any shape may be used, including but not limited to, square, triangular, diamond, star, pentagonal or hexagonal.

The head may be any size; the head is preferably between 1 cm and 100 cm in diameter, with a preferred diameter of 5 to 15, preferably 10 cm. Different head sizes may be used for different animal species, although the heads would fit on the same size grooming tool. For instance, for a cat a head with a diameter of 7 cm may be used, while for a horse a head with a diameter of 15 cm may be used. The type of bristles used may also be different; while one used the same grooming tool, soft hair bristles may be used on the cat while harder plastic bristles are used on the horse.

The handle 13 may be ergonomically designed, and may be any shape or design. It may be covered with a covering 14, which may be soft for comfort or may be a material that allows better traction or gripping. The covering 14 may cover the entire handle or portions of the handle. The covering 14 is optional.

The rear cover 15 may use any type of mechanism for opening, such as but not limited to, a spring loaded clip, a hinge mechanism, or a slot and groove mechanism.

The push plate 21 may be permanently affixed or may be removable. In the case of interchangeable heads, the push plate is affixed to a head by forcing the bristles 36 of the head 12 through holes in the push plate, such that the push plate 21 rests flush against the head 12, as in FIG. 1. The push plate may be any shape or size, but preferably conforms in shape to the head. The holes in the push plate that pass over the bristles may be any shape or size, but are preferably round and are preferably comparable in size to the bristles such that there is sufficient contact between the push plate and the bristles to remove hair or fur from the bristles. The holes in the push plate may contain barbed sides or other features for more efficiently removing hair or fur from bristles.

The electrical vibration device may vibrate the head in any direction, including but not limited to, circular, up and down, side to side, or any combination of all or any of the above.

The head may have a swivel function. This may be achieved through any mechanism, including but not limited to, a ball and socket, universal joint, or flexible joint. The swivel function allows the head to maintain contact with the pet regardless of the position of the handle. The pivot may have a limited range of motion or a full range of motion.

The invention may have interchangeable heads that have a trimmer for trimming long or thick pet hair. The trimmer could be a razor or a comb with blades. The trimmer could be disposed on a portion of the head while the remainder of the head contains bristles, and could be integral to the head or could be removable. The trimmer may function as a trimmer or as a comb.

The present invention is an improvement over the prior art relating to pet grooming devices in that it has a vibration device which can be used to massage a pet, interchangeable heads which allow flexibility in types of massage and types of pets that can be massaged with this grooming tool, and a push plate with makes hair or fur removal from the bristles possible using just one hand, thus freeing a hand for controlling the pet or animal. The components are all integrated into a compact design with an ergonomically correct handle, which makes the invention easy to use.

The grooming tool maybe self-contained, being powered by a battery in a battery compartment, so it doesn't need to be plugged into an outlet, and thus may be used anywhere. For instance, one may use it at a dog or cat show to groom pets before showing, or on a farm to groom a horse or goat. The interchangeable heads may make it useful for nearly any type of animal, and households with multiple animals may want a separate head for each pet.

The grooming tool may have a function that also allows a user to wash an animal. This washer function may be a tube disposed in the handle that can be filled with liquid through a pluggable hole in the handle body; the liquid could then be dispensed out the head of the invention through the bristles or through holes in the head by pressing a trigger or button. Alternately, there may be a threaded connector on the rear cover 15 that connects to a faucet or hose for continuous water flow through the tube.

The materials of manufacture for the invention include, but are not limited to, plastics, rubbers, metals, hair or animal products, glass or glass products, elastomers, thermoplastic elastomers, textiles, or any combination of these or other materials.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. A portable pet grooming tool, comprising:
a handle, sized and shaped to fit a grasping adult human hand and to house a standard battery;
a body rigidly connected to said handle and containing a battery powered DC motor functionally connected to said standard battery via a variable potentiometer;
a vibration causing, rotatable element having an eccentric weight distribution, connected to said motor such that rotation of said motor causes said rotatable element to rotate and vibrate;
a vibration level control knob, mechanically connected to said variable potentiometer such that movement of said control knob alters an amount of current being supplied by said battery to said battery powered DC motor, thereby varying a speed of rotation of said motor and of said rotatable element, thereby altering a degree of vibration caused by said rotatable element;
a head, removably attached to said body, comprising one or more bristles attached to a bristle face of said head; and
a push plate, removably attached to said head and shaped to conform to said bristle face of said head, said push plate comprising one or more holes shaped to be a close fit to said one or more bristles.

2. The grooming device of claim 1 wherein said push plate is operated by a button and reset device in the body.

3. The grooming device of claim 2, wherein said button moves said push plate out from said body when said button is pushed inward.

4. The grooming device of claim 3, wherein said push plate is controlled by a button and a reset device; said button pushes said push plate to an outer position, and said reset device returns said push plate to the starting position.

5. The grooming device of claim 1 wherein said head further comprises a fur trimmer.

6. The grooming device of claim 1 wherein said head further comprises a liquid dispenser.

7. The grooming device wherein said body is attached to said handle via a swivel joint.
